(19) United States
(12) Patent Application Publication
(10) Pub. No.: US 2025/0298872 A1
(43) Pub. Date: Sep. 25, 2025

(54) INFORMATION PROCESSING SYSTEM AND NON-TRANSITORY COMPUTER READABLE MEDIUM

(71) Applicant: FUJIFILM Business Innovation Corp., Tokyo (JP)

(72) Inventor: Misaki MATSUZAWA, Kanagawa (JP)

(73) Assignee: FUJIFILM Business Innovation Corp., Tokyo (JP)

(21) Appl. No.: 18/778,222

(22) Filed: Jul. 19, 2024

(30) Foreign Application Priority Data
Mar. 21, 2024 (JP) 2024-044899

(51) Int. Cl. G06F 21/31; G06V 20/52

(52) U.S. Cl. CPC G06F 21/31; G06V 20/52

(57) ABSTRACT

An information processing system includes one or a plurality of processors configured to: acquire staying person information regarding a staying person standing around an apparatus; and select a specific authentication method used when the apparatus authenticates a user in accordance with the staying person information, from a plurality of authentication methods.

### CROSS-REFERENCE TO RELATED APPLICATIONS

This application is based on and claims priority under 35 USC 119 from Japanese Patent Application No. 2024-044899 filed Mar. 21, 2024.

### BACKGROUND

### (i) Technical Field

The present disclosure relates to an information processing system and a non-transitory computer readable medium.

### (ii) Related Art

Japanese Unexamined Patent Application Publication No. 2004-102708 discloses an image processing apparatus that stores an authentication level set based on an image processing amount predicted depending on at least one of calendar and time, authenticates a user by switching the authentication level based on at least one of the calendar and the time when image processing is requested for image data, and executes the requested image processing in accordance with a result of the authentication.

Japanese Unexamined Patent Application Publication No. 2019-160058 discloses an authentication method as follows. An apparatus accepts input of first authentication information, the first authentication information is received from the apparatus, and user authentication is executed based on the first authentication information. Whether or not second authentication information is required is determined based on location information of the apparatus, and upon determining that the second authentication information is required, security information for requesting an input of the second authentication information is sent to the apparatus. The apparatus receives the security information and accepts input of the second authentication information, the second authentication information is received from the apparatus, and the user authentication is executed based on the second authentication information.

### SUMMARY

Authentication of a user by an apparatus, using an authentication method depending on at least one of calendar and time or an authentication method depending on a location where the apparatus is placed, cannot authenticate a user by using an appropriate authentication method in accordance with information of a staying person standing around the apparatus.

Aspects of non-limiting embodiments of the present disclosure relate to enabling an apparatus to authenticate a user by using an appropriate authentication method in accordance with information of a staying person standing around the apparatus.

Aspects of certain non-limiting exemplary embodiments of the present disclosure address the above advantages and/or other advantages not described above. However, aspects of the non-limiting exemplary embodiments are not required to address the advantages described above, and aspects of the non-limiting exemplary embodiments of the present disclosure may not address advantages described above.

According to an aspect of the present disclosure, there is provided an information processing system including one or a plurality of processors configured to: acquire staying person information regarding a staying person standing around an apparatus; and select a specific authentication method used when the apparatus authenticates a user in accordance with the staying person information, from a plurality of authentication methods.

### BRIEF DESCRIPTION OF THE DRAWINGS

Exemplary embodiments of the present disclosure will be described in detail based on the following figures, wherein:

FIG. 1 is a diagram illustrating an example of an overall configuration of an image processing system according to the present exemplary embodiment;

FIG. 2 is a diagram illustrating an example of a hardware configuration of a cloud server according to the present exemplary embodiment;

FIG. 3 is a diagram illustrating an example of a hardware configuration of an image processing apparatus according to the present exemplary embodiment;

FIG. 4 is a diagram illustrating an example of a user operation performed on an image processing system of a first aspect;

FIG. 5 is a diagram illustrating an example of a user operation performed on an image processing system of a second aspect;

FIG. 6 is a diagram illustrating an example of a user operation performed on an image processing system of a third aspect;

FIG. 7 is a diagram illustrating an example of a user operation performed on an image processing system of a fourth aspect;

FIG. 8 is a block diagram illustrating an example of a functional configuration of the cloud server according to the present exemplary embodiment;

FIG. 9 is a sequence diagram illustrating an example of an operation of the image processing system of the first aspect;

FIG. 10 is a sequence diagram illustrating an example of an operation of the image processing system of the second aspect;

FIG. 11 is a sequence diagram illustrating an example of an operation of the image processing system of the third aspect; and

FIG. 12 is a sequence diagram illustrating an example of an operation of the image processing system of the fourth aspect.

### DETAILED DESCRIPTION

In the following, exemplary embodiments of the present invention will be described in detail with reference to the accompanying drawings.

### Outline of the Present Exemplary Embodiment

The present exemplary embodiments provide an information processing system configured to acquire staying person information regarding a person standing around an apparatus (hereinafter, referred to as “staying person”), and selects a specific authentication method used when the apparatus authenticates a user in accordance with the staying person information, from a plurality of authentication methods.

Here, the “system” may be configured by a single apparatus, or may be configured by a plurality of apparatuses. In the following, an information processing system configured by a single apparatus will be described as an example, and a cloud server will be described as an example of the single apparatus.

Although the apparatus may be an apparatus that performs any kind of processing, hereinafter, an image processing apparatus that performs image processing will be described as an example.

### Overall Configuration of Image Processing System

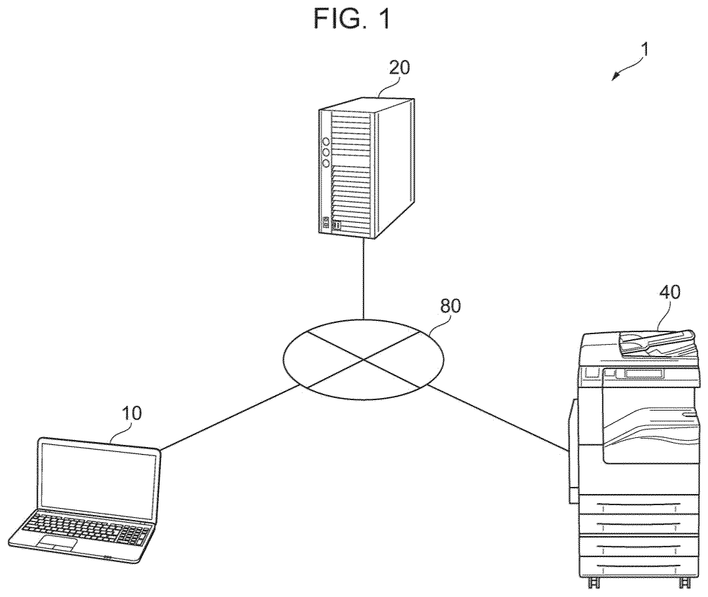

FIG. 1 is a diagram illustrating an example of an overall configuration of an image processing system 1 according to the present exemplary embodiment. As illustrated in the figure, the image processing system 1 includes a terminal apparatus 10, a cloud server 20, and an image processing apparatus 40 that are coupled to each other over a communication network 80.

The terminal apparatus 10 is a computer used by a user. The terminal apparatus 10 is used by a user to create document data (also simply referred to as a “document”) and register the document data to the cloud server 20. As the terminal apparatus 10, for example, a desktop PC, a notebook PC, a portable information terminal, or the like may be used. Although only one terminal apparatus 10 is illustrated in FIG. 1, a plurality of the terminal apparatuses 10 may be provided.

The cloud server 20 is a server computer that provides a cloud service of storing document data registered by a user from the terminal apparatus 10, and transmitting the document data to the image processing apparatus 40 in response to a request from the image processing apparatus 40. Note that although only one cloud server 20 is illustrated in FIG. 1, a plurality of cloud servers 20 may be provided. Further, an ordinary server computer may be used instead of the cloud server 20.

The image processing apparatus 40 is an apparatus that performs image processing such as image formation on a recording medium such as paper, image reading from a recording medium such as paper, image transmission to a public network, and image reception from the public network. The image processing apparatus 40 is a printer from the viewpoint of performing only image formation, a copier from the viewpoint of performing image capturing and image formation, and a facsimile from the viewpoint of performing image reading, image transmission or image reception, and image formation. Note that although only one image processing apparatus 40 is illustrated in FIG. 1, the plurality of image processing apparatuses 40 may be provided.

The communication network 80 is a network used for information communication between the terminal apparatus 10 and the cloud server 20, and between the image processing apparatus 40 and the cloud server 20. As the communication network 80, for example, the Internet or a local area network (LAN) may be used.

### Hardware Configuration of Cloud Server

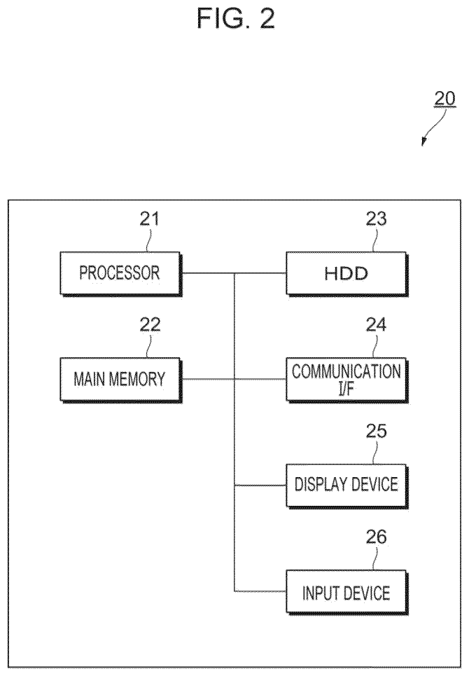

FIG. 2 is a diagram illustrating an example of a hardware configuration of the cloud server 20 according to the present exemplary embodiment. As illustrated in the figure, the cloud server 20 includes a processor 21, a main memory 22, a hard disk drive (HDD) 23, a communication interface (hereinafter, referred to as “communication I/F”) 24, a display device 25, and an input device 26.

The processor 21 executes various types of software, such as an operating system (OS) and applications, and achieves functions described later.

The main memory 22 is a memory used as a working memory or the like of the processor 21.

The HDD 23 is, for example, a magnetic disk device that stores input data to various types of software and output data from various types of software.

The communication I/F 24 transmits and receives various types of information to and from the terminal apparatus 10, and transmits and receives various types of information to and from the image processing apparatus 40 over the communication network 80.

The display device 25 is, for example, a display that displays various types of information.

The input device 26 is, for example, a keyboard or a mouse used by a user to input information.

The hardware configuration illustrated in FIG. 2 may be considered as a hardware configuration of the terminal apparatus 10. When the terminal apparatus 10 is described, the processor 21, the main memory 22, the HDD 23, the communication I/F 24, the display device 25, and the input device 26 in FIG. 2 are referred to as a processor 11, a main memory 12, an HDD 13, a communication I/F 14, a display device 15, and an input device 16, respectively.

### Hardware Configuration of Image Processing Apparatus

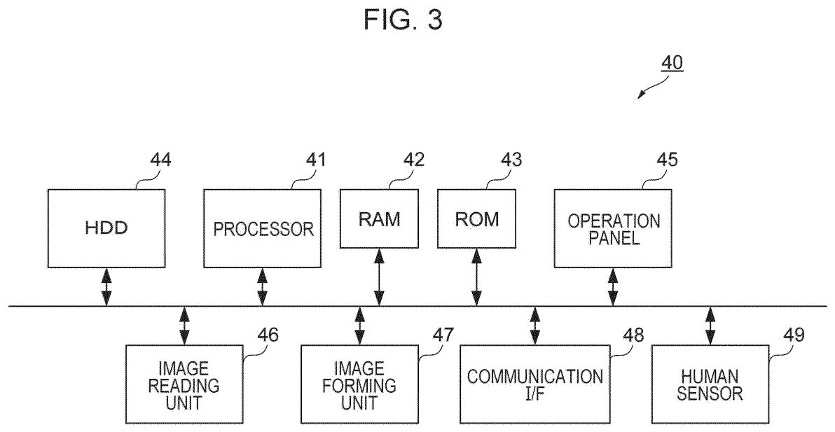

FIG. 3 is a diagram illustrating an example of a hardware configuration of the image processing apparatus 40 according to the present exemplary embodiment. As illustrated in the figure, the image processing apparatus 40 includes a processor 41, a random access memory (RAM) 42, a read only memory (ROM) 43, an HDD 44, an operation panel 45, an image reading unit 46, an image forming unit 47, a communication I/F 48, and a human sensor 49.

The processor 41 achieves each function which will be described later by loading various types of programs stored in the ROM 43 or the like into the RAM 42 and executing the programs.

The RAM 42 is a memory used as a working memory or the like of the processor 41.

The ROM 43 is a memory that stores various types of programs to be executed by the processor 41.

The HDD 44 is, for example, a magnetic disk device that stores image data read by the image reading unit 46, image data used for image formation in the image forming unit 47, and the like.

The operation panel 45 is, for example, a touch panel that displays various types of information and receives operation input from a user. Here, the operation panel 45 includes a display on which various types of information are displayed and a position detection sheet for detecting a position pointed by a pointing means such as a finger or a stylus pen. Alternatively, a display and a keyboard may be used instead of the touch panel.

The image reading unit 46 reads an image recorded on a recording medium such as paper. Here, the image reading unit 46 is, for example, a scanner, and a CCD type thereof in which reflected light of light irradiated to a document from a light source is reduced by a lens and received by a charge coupled device (CCD), or a contact image sensor (CIS) type thereof in which reflected light of light sequentially irradiated to a document from an LED light source is received by a CIS may be used.

The image forming unit 47 forms an image on a recording medium such as paper. Here, the image forming unit 47 is, for example, a printer, and an electrophotographic method type printer in which toner adhered to a photoreceptor is transferred onto a recording medium to form an image, or an inkjet method type printer in which ink is ejected onto a recording medium to form an image.

The communication I/F 48 transmits and receives various types of information to and from the cloud server 20 over the communication network 80.

The human sensor 49 detects a person existing around the image processing apparatus 40. A specific example of the human sensor 49 will be described later in detail.

### Problems and Solutions of Image Processing System

In the image processing system 1 as described above, the image processing apparatus 40 may be installed in a public area where a large number of irrelative persons capable of being connected by wireless exist. In the case above, multi-factor authentication for a user (user A), having a valid authority to operate the image processing apparatus 40 and execute printing, is required to be performed in a state satisfying an appropriate security level.

However, in a case that the authentication method of the multi-factor authentication used by the user A is statically determined by the installation position of the image processing apparatus 40, the time used by the user, or the like, if the user authentication information used by the user A in the multi-factor authentication is stolen, the user authentication information may be misused at the image processing apparatus 40.

In the image processing system 1 of the present exemplary embodiment, therefore, the image processing apparatus 40 acquires information of a staying person, who has stayed around the image processing apparatus 40 for a predetermined time or more, using the human sensor 49, and transmits the acquired information to the cloud server 20. The cloud server 20 dynamically switches the authentication method of the multi-factor authentication used by the user A to the authentication method of a security level in accordance with the acquired information, and uses the authentication method to prevent loss due to the stealing. Note that the authentication method and its selection conditions are assumed to be set by the user A in advance.

Furthermore, the cloud server 20 determines a default authentication method in advance, switches to an authentication method with a high security level in a high-risk situation, and switches to an authentication method with a low security level in a low-risk situation to maintain an appropriate security level.

Incidentally, in the present exemplary embodiment, the image processing apparatus 40 detects a surrounding situation by, for example, the human sensor 49 to be described below and transmits the surrounding situation to the cloud server 20, and the cloud server 20 dynamically switches the authentication method in accordance with the surrounding situation of the image processing apparatus 40. However, since the information that can be detected and the content that can be determined by each human sensor 49 is limited, it is desirable to improve the detection accuracy of the situation around the image processing apparatus 40 by using a plurality of human sensors 49 in combination. Note that the information that can be detected by the human sensor 49 is merely an example, and the present invention is not limited thereto.

As the human sensor 49, first, there is a reflection sensor 49a. The reflection sensor 49a detects a human body or an object existing in front with a light interruption situation in front. It is conceivable that the security level is made higher when a plurality of users are detected, and the security level is made lower when only one user is detected.

A second example of the human sensor 49 is a pyroelectric infrared sensor 49b. The pyroelectric infrared sensor 49b detects whether an object is a human body or a non-human body with a temperature difference of the object existing in front. It is conceivable that the security level is made higher when a plurality of users are detected, and the security level is made lower when only one user is detected.

A third example of the human sensor 49 is a camera sensor 49c. The camera sensor 49c visually captures a human body or an object existing in front and detects an orientation of the human body or the object. For example, the camera sensor 49c detects a line of sight, an orientation of a foot, or the like of a person. It is conceivable that the security level is made higher when lines of sight of a plurality of users are detected, and the security level is made lower when a line of sight of only one user is detected. Further, it is conceivable that the security level is made higher when a plurality of foot orientations of users are directed to the image processing apparatus 40, and the security level is made lower when the foot orientations of users are not directed to the image processing apparatus 40.

A fourth example of the human sensor 49 is a vibration sensor 49d. The vibration sensor 49d detects any vibrations in the surroundings and detects a congestion situation or the like in the surroundings. It is conceivable that the security level is made higher when the number of vibrations is large and the security level is made lower when the number of vibrations is small.

A fifth example of the human sensor 49 is a sound detection sensor 49e. The sound detection sensor 49e detects any sounds in the surroundings, and detects a congestion situation or the like in the surroundings. It is conceivable that the security level is made higher when a plurality of sounds are detected and the security level is made lower when no sound is detected.

### Outline of Image Processing System

### First Aspect

In the image processing system 1 according to a first aspect, the cloud server 20 selects the authentication method based on the information detected by the reflection sensor 49a.

Although the pyroelectric infrared sensor 49b or the camera sensor 49c may be used instead of the reflection sensor 49a or in combination with the reflection sensor 49a, the following description will be made on the assumption that the reflection sensor 49a is used.

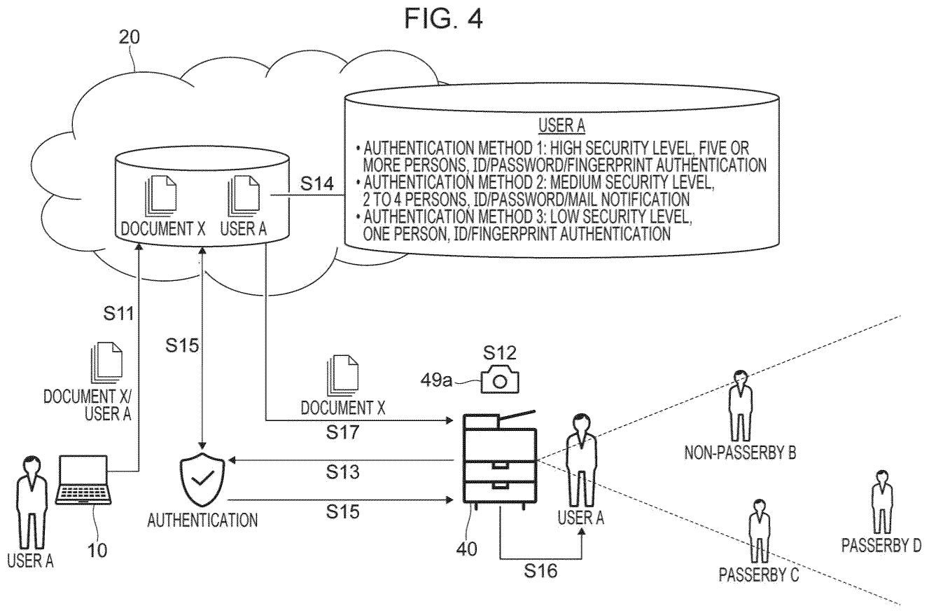

FIG. 4 is a diagram illustrating an example of a user operation performed on the image processing system 1 of the first aspect.

As illustrated in the figure, it is assumed that the user A has set authentication methods 1 to 3 in accordance with the security levels and their selection conditions in advance.

Specifically, “ID/password/fingerprint authentication” that is an authentication method whose security level is “high” is set as the authentication method 1. Here, the “ID/password/fingerprint authentication” is an authentication method in which a user ID is input, authentication using a password is performed, and authentication using a fingerprint is performed. Further, it is also set that the authentication method 1 is selected in a case that the number of staying persons is five or more.

Furthermore, “ID/password/mail notification” that is an authentication method whose security level is “middle” is set as the authentication method 2. Here, “ID/password/mail notification” is an authentication method in which a user ID is input, authentication using a password is performed, and authentication using a passcode sent by e-mail is performed. Further, it is also set that the authentication method 2 is selected in a case that the number of staying persons is two to four.

Furthermore, “ID/fingerprint authentication” that is an authentication method whose security level is “low” is set as the authentication method 3. Here, “ID/fingerprint authentication” is an authentication method in which a user ID is input and authentication using a fingerprint is performed. Further, it is also set that the authentication method 3 is selected in a case that the number of staying persons is one.

In this state, it is assumed that two persons, that is, a user A who has a valid authority and a non-passerby B who does not have a valid authority are standing around the image processing apparatus 40.

In the case above, it is assumed that the user A stands in front of the image processing apparatus 40 and performs the multi-factor authentication to print a document X stored in the cloud server 20. At that time, the cloud server 20 selects an authentication method suited to the situation around the image processing apparatus 40. In this example, since the number of staying persons detected by the reflection sensor 49a is two, the cloud server 20 selects the authentication method 2. Thus, the user A is authenticated by “ID/password/mail notification”, and in a case that the authentication is successful, the document X can be printed.

Further, it is assumed that the non-passerby B performs multi-factor authentication after the user A has left. At this time, the cloud server 20 dynamically switches the authentication method. In this example, since the number of staying persons detected by the reflection sensor 49a decreases from two to one, the cloud server 20 switches the authentication method 2 used by the user A to the authentication method 3. With this, the non-passerby B is not allowed to be authenticated by “ID/password/mail notification”, thereby preventing unauthorized use of the image processing apparatus 40 by others.

A flow of a specific user operation will be described below.

First, the user A logs in to the cloud server 20 and registers the document X and the user ID in the cloud server 20 (S11). Although the print instruction of the document X may be registered in the cloud server 20, the following description will be made on the assumption that the document X is registered.

Next, in the image processing apparatus 40, the reflection sensor 49a detects “two persons” of the user A and the non-passerby B as the number of staying persons standing for a predetermined time (for example, five seconds) or more (S12).

The image processing apparatus 40 makes an access request to the cloud server 20, and transmits “two persons” obtained from the reflection sensor 49a (S13).

With this, the cloud server 20 selects the authentication method 2 from the authentication methods 1 to 3 based on the information “two persons” obtained from the image processing apparatus 40 (S14).

The cloud server 20 notifies the authentication method 2 to the image processing apparatus 40 (S15).

As a result, the user A is authenticated by “ID/password/mail notification” in the image processing apparatus 40 (S16).

When the authentication is successful, the user A acquires the document X from the cloud server 20 and prints the document X (S17).

In the above description, the number of staying persons standing around the image processing apparatus 40 is used as the information that affects the risk of the user authentication information of a valid user of the image processing apparatus 40 being stolen, but it is not limited thereto. A state of a staying person, such as an orientation of the staying person standing around the image processing apparatus 40, may be used as such information.

### Second Aspect

In the image processing system 1 according to a second aspect, the cloud server 20 switches the authentication method from the default authentication method based on the information detected by the reflection sensor 49a.

Although the pyroelectric infrared sensor 49b or the camera sensor 49c may be used instead of the reflection sensor 49a or in combination with the reflection sensor 49a, the following description will be made on the assumption that the reflection sensor 49a is used.

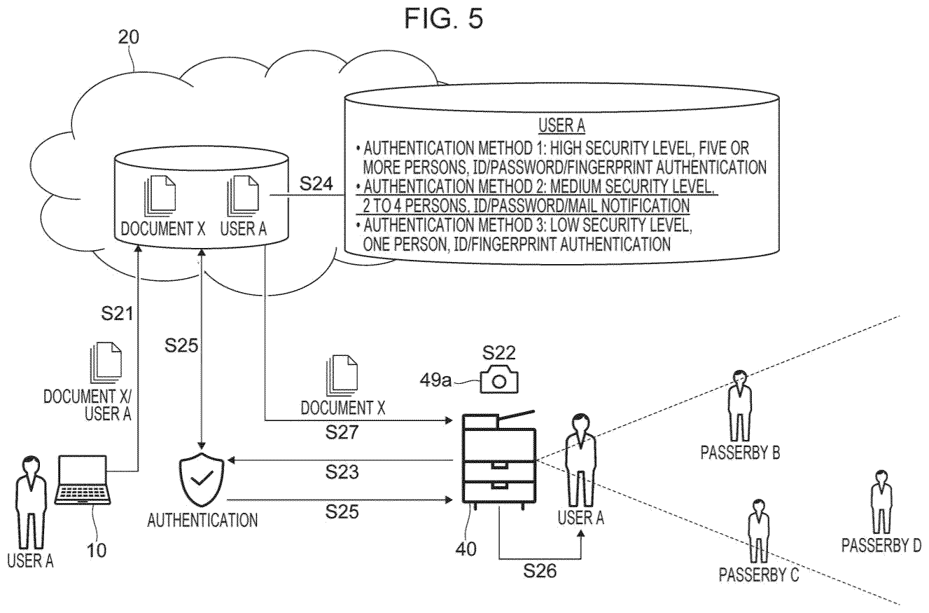

FIG. 5 is a diagram illustrating an example of a user operation performed on the image processing system 1 of the second aspect.

As illustrated in the figure, it is assumed that the user A has set authentication methods 1 to 3 in accordance with the security levels and their selection conditions in advance. Further, it is assumed that the user A sets the authentication method 2 as the default authentication method as indicated by underlining. Since the contents of the authentication methods 1 to 3 are the same as those of the first aspect, a description thereof will be omitted.

In this state, consider a case that only the user A having valid authority is standing around the image processing apparatus 40.

In the case above, it is assumed that the user A stands in front of the image processing apparatus 40 and performs the multi-factor authentication to print the document X stored in the cloud server 20. At this time, the cloud server 20 switches the default authentication method to an authentication method suited to the situation around the image processing apparatus 40. In this example, the number of staying persons detected by the reflection sensor 49a is one, and a non-passerby who may be a malicious user does not exist around the image processing apparatus 40. For that reason, a risk that the user ID, the password, and the like are stolen is low, and the cloud server 20 switches the authentication method from the default authentication method 2 to the authentication method 3 in which the number of operations is less to simplify the operation procedure.

A flow of a specific user operation will be described below.

First, the user A logs in to the cloud server 20 and registers the document X and the user ID in the cloud server 20 (S21). Although the print instruction of the document X may be registered in the cloud server 20, the following description will be made on the assumption that the document X is registered.

Next, in the image processing apparatus 40, the reflection sensor 49a detects “one person” who is the user A as the number of staying persons standing for a predetermined time (for example, five seconds) or more (S22).

The image processing apparatus 40 makes an access request to the cloud server 20 and transmits “one person” obtained from the reflection sensor 49a (S23).

With this, the cloud server 20 selects the authentication method 3 from the authentication methods 1 to 3 based on the information of “one person” obtained from the image processing apparatus 40, and changes the default authentication method 2 to the selected authentication method 3 (S24).

The cloud server 20 notifies the authentication method 3 to the image processing apparatus 40 (S25).

As a result, the user A is authenticated by “ID/fingerprint authentication” in the image processing apparatus 40 (S26).

When the authentication is successful, the user A acquires the document X from the cloud server 20 and prints the document X (S27).

In the above description, the number of staying persons standing around the image processing apparatus 40 is used as the information that affects the risk of the user authentication information of a valid user of the image processing apparatus 40 being stolen, but it is not limited thereto. A state of a staying person, such as an orientation of the staying person standing around the image processing apparatus 40, may be used as such information.

### Third Aspect

In a case that the installation location of the image processing apparatus 40 is a location such as a store or an office where the population density is always high, there is a possibility that passersby always continue to exist around the image processing apparatus 40. In the case above, in the S12 of the first aspect or the S22 of the second aspect, when the reflection sensor 49a acquires the number of staying persons standing around the image processing apparatus 40, the reflection sensor 49a ceaselessly detects passersby within a detection range. For that reason, there is a problem that the number of staying persons standing around the image processing apparatus 40 is erroneously detected and, for example, a complicated authentication method is erroneously selected, thereby increasing the number of procedures.

In the image processing system 1 of the third aspect, therefore, the cloud server 20 selects the authentication method based on the information detected by the reflection sensor 49a and the information detected by the vibration sensor 49d.

Specifically, the cloud server 20 acquires information of passersby around the image processing apparatus 40 detected by the vibration sensor 49d, in addition to information of a human body or an object standing in front of the image processing apparatus 40 detected by the reflection sensor 49a. That is, the cloud server 20 acquires information of a human body or an object standing in front of the image processing apparatus 40 in combination with information of how much traffic is there, thereby detecting the situation around the image processing apparatus 40 in more detail to reduce false detection. As a result, the cloud server 20 can select and dynamically switch to an appropriate authentication method, and thus can select an operation procedure appropriate for the user in accordance with the installation situation of the image processing apparatus 40.

Although the pyroelectric infrared sensor 49b or the camera sensor 49c may be used instead of the reflection sensor 49a or in combination with the reflection sensor 49a, the following description will be made on the assumption that the reflection sensor 49a is used.

Although the sound detection sensor 49e may be used instead of the vibration sensor 49d or in combination with the vibration sensor 49d, the following description will be made on the assumption that the vibration sensor 49d is used.

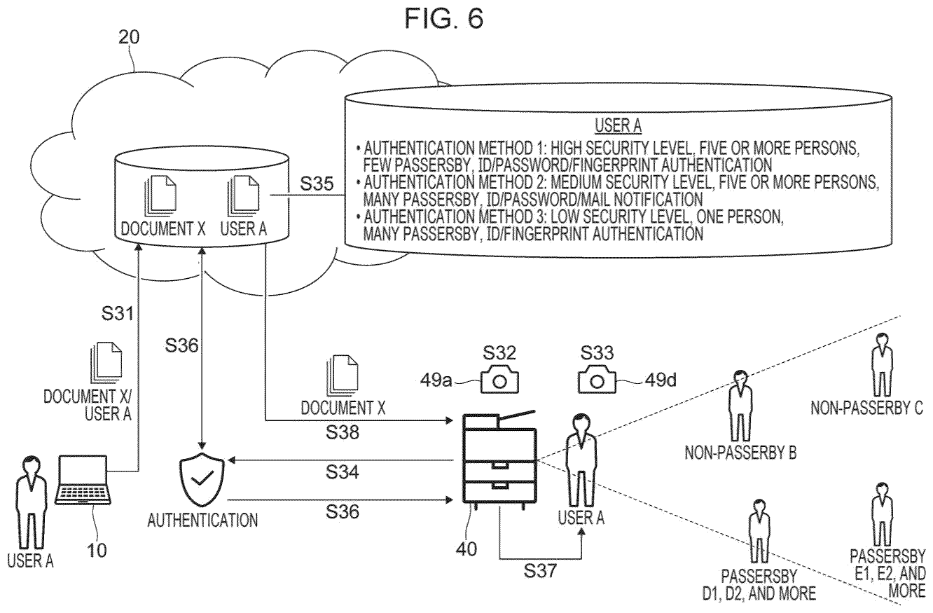

FIG. 6 is a diagram illustrating an example of a user operation performed on the image processing system 1 of the third aspect.

As illustrated in the figure, it is assumed that the user A has set authentication methods 1 to 3 in accordance with the security levels and their selection conditions in advance.

Specifically, “ID/password/fingerprint authentication” that is an authentication method whose security level is “high” is set as the authentication method 1. It is also set that the authentication method 1 is selected in a case that the number of staying persons is five or more and there are few passersby.

Further, “ID/password/mail notification” that is an authentication method whose security level is “middle” is set as the authentication method 2. It is also set that the authentication method 2 is selected in a case that the number of staying persons is five or more and there are many passersby.

Furthermore, “ID/fingerprint authentication” that is an authentication method whose security level is “low” is set as the authentication method 3. It is also set that the authentication method 3 is selected in a case that the number of staying persons is one and there are many passersby.

Note that although the expressions “many” and “few” are used in the third aspect, a case that the number of passersby is larger than a predetermined value may be defined as “many” and a case that the number of passersby is smaller than the predetermined value may be defined as “few”. Further, the number of passersby may be stored instead of the passersby being “many” or “few”.

Furthermore, although an authentication method selected in a case that the number of staying persons is two to four and an authentication method selected in a case that the number of staying persons is one and there are a few passersby are not illustrated in the drawing, these authentication methods may also be set.

A flow of a specific user operation will be described below.

First, the user A logs in to the cloud server 20 and registers the document X and the user ID in the cloud server 20 (S31). Although the print instruction of the document X may be registered in the cloud server 20, the following description will be made on the assumption that the document X is registered.

Next, in the image processing apparatus 40, the reflection sensor 49a acquires “five persons” as the number of staying persons standing for a predetermined time (for example, five seconds) or more (S32). Here, the “five persons” are the user A and the non-passersby B and C correctly recognized by the reflection sensor 49a, the passerby D being erroneously recognized as the passersby D1, D2, and more by the reflection sensor 49a, and the passerby E being erroneously recognized as the passersby E1, E2, and more by the reflection sensor 49a.

Further, in the image processing apparatus 40, the vibration sensor 49d detects that there are many passersby based on the vibrations caused by the passersby D1, D2, and more and the passersby E1, E2, and more (S33).

The image processing apparatus 40 makes an access request to the cloud server 20, and transmits “five persons” obtained from the reflection sensor 49a and “many passersby” obtained from the vibration sensor 49d (S34).

With this, the cloud server 20 selects the authentication method 2 from the authentication methods 1 to 3 based on the information “five persons” and the information “many passersby” obtained from the image processing apparatus 40 (S35). That is, although five or more persons are detected by the reflection sensor 49a, it is determined that there are many passersby by the vibration sensor 49d, and this determines that it is not necessary to increase the security level to the authentication method 1 and makes the authentication method 2 be selected.

The cloud server 20 notifies the authentication method 2 to the image processing apparatus 40 (S36).

As a result, the user A is authenticated by “ID/password/mail notification” in the image processing apparatus 40 (S37).

When the authentication is successful, the user A acquires the document X from the cloud server 20 and prints the document X (S38).

In the above description, the number of staying persons standing around the image processing apparatus 40 is used as the information that affects the risk of the user authentication information of a valid user of the image processing apparatus 40 being stolen, but it is not limited thereto. A state of a staying person, such as an orientation of the staying person standing around the image processing apparatus 40, may be used as such information.

### Fourth Aspect

For the same problem as described in the third aspect, in the image processing system 1 of the present exemplary embodiment, the cloud server 20 selects the authentication method based on the information detected by the reflection sensor 49a and the information obtained by a map application.

Specifically, working together with the map application, the cloud server 20 acquires the congestion degree, which is the number of persons per unit area for each time zone of the surrounding buildings accumulated in the map application, based on the position information of the image processing apparatus 40. The cloud server 20 dynamically determines an authentication method based on the information acquired from the reflection sensor 49a and the information obtained from the map application, thereby correcting erroneous detection in a case that five or more passersby are constantly detected and selecting an appropriate authentication method to prevent an increase in the number of procedures.

Although the pyroelectric infrared sensor 49b or the camera sensor 49c may be used instead of the reflection sensor 49a or in combination with the reflection sensor 49a, the following description will be made on the assumption that the reflection sensor 49a is used.

Furthermore, although another application that can accumulate the congestion degree may be used instead of the map application or in combination with the map application, the following description will be made on the assumption that the map application is used.

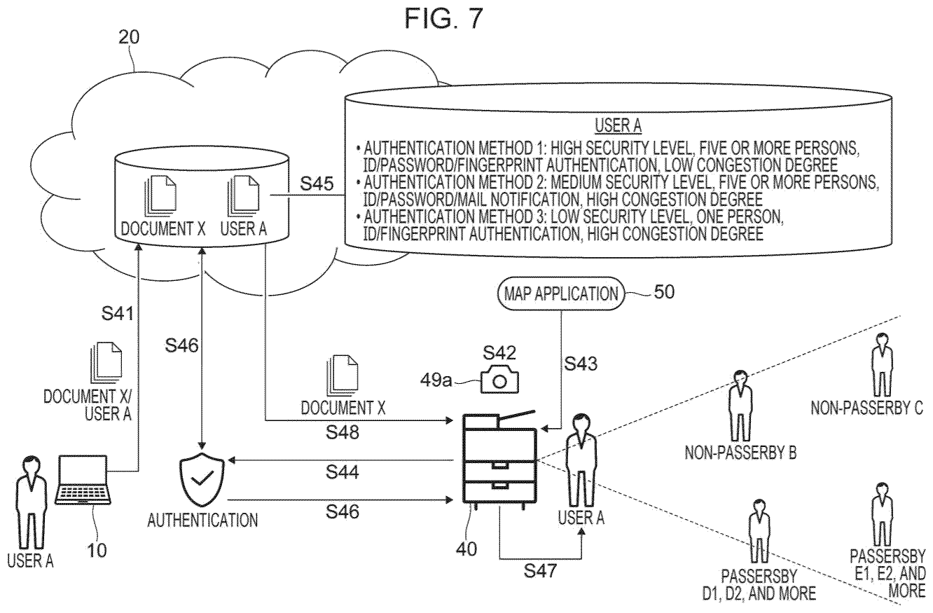

FIG. 7 is a diagram illustrating an example of a user operation on the image processing system 1 of the fourth aspect.

As illustrated in the figure, it is assumed that the user A has set authentication methods 1 to 3 in accordance with the security levels and their selection conditions in advance.

Specifically, “ID/password/fingerprint authentication” that is an authentication method whose security level is “high” is set as the authentication method 1. It is also set that the authentication method 1 is selected in a case that the number of staying persons is five or more and the congestion degree is low.

Further, “ID/password/mail notification” that is an authentication method whose security level is “middle” is set as the authentication method 2. It is also set that the authentication method 2 is selected in a case that the number of staying persons is five or more and the congestion degree is high.

Furthermore, “ID/fingerprint authentication” that is an authentication method whose security level is “low” is set as the authentication method 3. It is also set that the authentication method 3 is selected in a case that the number of staying persons is one and the congestion degree is high.

Note that, in the fourth aspect, the expressions “high” and “low” are used for the congestion degree, and a case that the value of the congestion degree is larger than a predetermined value may be defined as “high”, and a case that the value of the congestion degree is smaller than the predetermined value may be defined as “low”. Further, instead of expressing the congestion degree as “high” or “low”, a value of the congestion degree may be stored.

Furthermore, although an authentication method selected in a case that the number of staying persons is two to four and an authentication method selected in a case that the number of staying persons is one and the congestion degree is low are not illustrated in the drawing, these authentication methods may also be set.

A flow of a specific user operation will be described below.

First, the user A logs in to the cloud server 20 and registers the document X and the user ID in the cloud server 20 (S41). Although the print instruction of the document X may be registered in the cloud server 20, the following description will be made on the assumption that the document X is registered.

Next, in the image processing apparatus 40, the reflection sensor 49a acquires “five persons” as the number of staying persons standing for a predetermined time (for example, five seconds) or more (S42). Here, the “five persons” are the user A and the non-passersby B and C correctly recognized by the reflection sensor 49a, the passerby D being erroneously recognized as the passersby D1, D2, and more by the reflection sensor 49a, and the passerby E being erroneously recognized as the passersby E1, E2, and more by the reflection sensor 49a.

Further, the image processing apparatus 40 acquires, from a map application 50, information indicating that the congestion degree of persons in an area where the image processing apparatus 40 is installed is high (S43).

The image processing apparatus 40 makes an access request to the cloud server 20, and transmits “five persons” obtained from the reflection sensor 49a and “high congestion degree” obtained from the map application 50 (S44).

With this, the cloud server 20 selects the authentication method 2 from the authentication methods 1 to 3 based on the information “five persons” and the information “high congestion degree” obtained from the image processing apparatus 40 (S45). That is, although five or more persons are detected by the reflection sensor 49a, since the congestion degree is determined to be high by the map application 50, it is determined that the security level need not be made higher to the authentication method 1 and the authentication method 2 is selected.

The cloud server 20 notifies the authentication method 2 to the image processing apparatus 40 (S46).

As a result, the user A is authenticated by “ID/password/mail notification” in the image processing apparatus 40 (S47).

When the authentication is successful, the user A acquires the document X from the cloud server 20 and prints the document X (S48).

In the above description, the number of staying persons standing around the image processing apparatus 40 is used as the information that affects the risk of the user authentication information of a valid user of the image processing apparatus 40 being stolen, but it is not limited thereto. A state of a staying person, such as an orientation of the staying person standing around the image processing apparatus 40, may be used as such information.

### Functional Configuration of Cloud Server

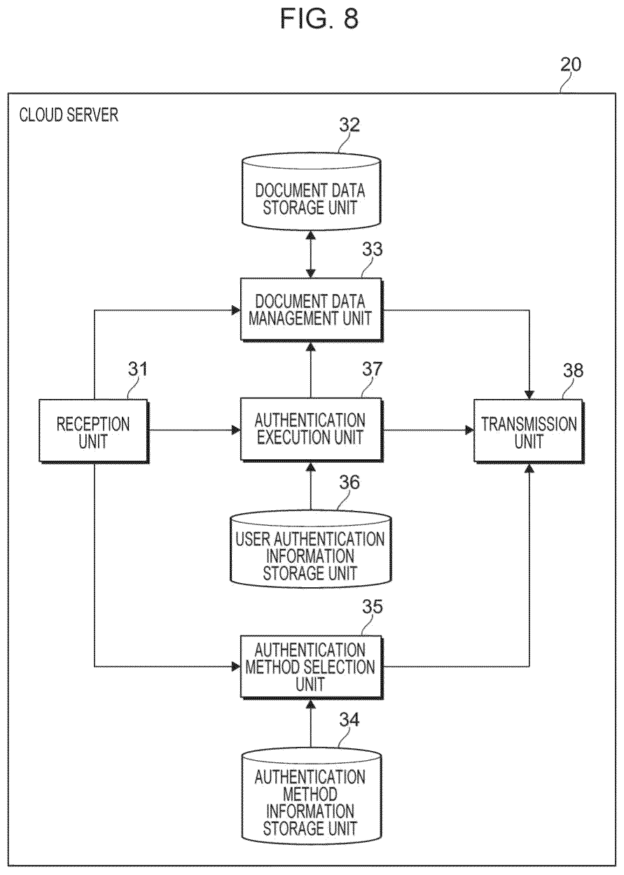

FIG. 8 is a block diagram illustrating an example of a functional configuration of the cloud server 20 according to the present exemplary embodiment. As illustrated in the figure, the cloud server 20 includes a reception unit 31, a document data storage unit 32, a document data management unit 33, an authentication method information storage unit 34, an authentication method selection unit 35, a user authentication information storage unit 36, an authentication execution unit 37, and a transmission unit 38.

When the user performs an operation to register document data in the cloud server 20 using the terminal apparatus 10, the reception unit 31 receives a document registration request including the user ID, the document ID, and the document data from the terminal apparatus 10.

Further, when the user performs an operation to access the cloud server 20 to retrieve document data by using the image processing apparatus 40, the reception unit 31 performs the following operation.

That is, in any of the first to fourth aspects, the reception unit 31 receives the access request including the user ID and the document ID and the information of the staying person detected by the reflection sensor 49a from the image processing apparatus 40.

Here, the information of the staying person may be any information regarding the staying person. For example, the information of the staying person may be the number of staying persons or may be a state of the staying person. Further, in a case that the information of the staying person is the state of the staying person, the state of the staying person may be, for example, the orientation of the staying person. In the present exemplary embodiment, this processing of the reception unit 31 is performed as an example of acquiring the staying person information regarding the staying person who is standing around the apparatus. Further, in the present exemplary embodiment, this processing of the reception unit 31 is performed as an example of acquiring the number of staying persons as the staying person information. Furthermore, in the present exemplary embodiment, this processing of the reception unit 31 is performed as an example of acquiring the state of the staying person as the staying person information. Still further, in the present exemplary embodiment, this processing of the reception unit 31 is performed as an example of acquiring the orientation of the staying person as the state of the staying person.

In particular, in the third aspect and the fourth aspect, the reception unit 31 receives information of a person (hereinafter, referred to as “existing person”) existing around the image processing apparatus 40 in addition to the access request and the information of the staying person detected by the reflection sensor 49a from the image processing apparatus 40. Here, the existing person includes a staying person standing around the image processing apparatus 40, and also includes a passerby passing around the image processing apparatus 40. In the present exemplary embodiment, this processing by the reception unit 31 is performed as an example of further acquiring existing person information regarding an existing person existing around the apparatus.

Among the above, in the third aspect, in addition to the access request and the information of the staying person detected by the reflection sensor 49a, the reception unit 31 receives the information of the passerby around the image processing apparatus 40 detected by the vibration sensor 49d as the information of the existing person from the image processing apparatus 40. In the present exemplary embodiment, the reflection sensor 49a is used as an example of a first type sensor, and information of a staying person detected by the reflection sensor 49a is used as an example of the staying person information detected by the first type sensor. Further, in the present exemplary embodiment, the vibration sensor 49d is used as an example of a second type sensor different from the first type, and information of a passerby detected by the vibration sensor 49d is used as an example of the existing person information detected by the second type sensor.

In the fourth aspect, in addition to the access request and the information of the staying person detected by the reflection sensor 49a, the reception unit 31 receives the congestion degree of persons around the image processing apparatus 40 obtained from the map application 50 as the information of the existing person from the image processing apparatus 40. In the present exemplary embodiment, the reflection sensor 49a is used as an example of a sensor, and information of a staying person detected by the reflection sensor 49a is used as an example of staying person information detected by the sensor. Further, in the present exemplary embodiment, the congestion degree obtained from the map application 50 is used as an example of the existing person information accumulated in the apparatus in advance.

Furthermore, when the user performs an authentication operation by using the image processing apparatus 40, the reception unit 31 receives user authentication information, which is selected by the authentication method selection unit 35 described later and is input in accordance with the authentication method presented by the image processing apparatus 40, from the image processing apparatus 40.

When the user performs an operation to register document data in the cloud server 20 by using the terminal apparatus 10, the document data storage unit 32 stores the document data included in the document registration request received by the reception unit 31.

When the user performs an operation to register document data in the cloud server 20 by using the terminal apparatus 10, the document data management unit 33 writes, into the document data storage unit 32, the document data included in the document registration request received by the reception unit 31. At this time, the document data management unit 33 associates the user ID and the document ID included in the document registration request received by the reception unit 31, thereby managing the document data written into the document data storage unit 32.

Further, when a user performs an operation for authentication to retrieve document data by using the image processing apparatus 40, in a case that the authentication is successful, the document data management unit 33 reads out the document data from the document data storage unit 32 based on the document ID associated with the user ID.

The authentication method information storage unit 34 stores, for each user, authentication method information in which a plurality of authentication methods that may be used for user authentication and selection conditions for selecting each of the plurality of authentication methods are linked with each other. For example, in the examples of FIG. 4 and FIG. 5, the selection condition for the authentication method 1 is that the number of staying persons is five or more, the selection condition for the authentication method 2 is that the number of staying persons is two to four, and the selection condition for the authentication method 3 is that the number of staying persons is one. Further, in the example of FIG. 6, the selection condition for the authentication method 1 is that the number of staying persons is five or more and there are few passersby, the selection condition for the authentication method 2 is that the number of staying persons is five or more and there are many passersby, and the selection condition for the authentication method 3 is that the number of staying persons is one and there are many passersby. Furthermore, in the example of FIG. 7, the selection condition for the authentication method 1 is that the number of staying persons is five or more and the congestion degree is low, the selection condition for the authentication method 2 is that the number of staying persons is five or more and the congestion degree is high, and the selection condition for the authentication method 3 is that the number of staying persons is one and the congestion degree is high. In particular, in the second aspect, the authentication method information storage unit 34 also stores information indicating which authentication method is the default authentication method. In the present exemplary embodiment, a plurality of authentication methods stored in the authentication method information storage unit 34 are used as an example of a plurality of authentication methods predetermined for a user.

When the user performs an operation of accessing the cloud server 20 to retrieve document data by using the image processing apparatus 40, the authentication method selection unit 35 reads out authentication method information corresponding to the user ID included in the access request received by the reception unit 31, from the authentication method information storage unit 34. The authentication method selection unit 35 performs the following operation.

That is, in any of the first to fourth aspects, the authentication method selection unit 35 selects an authentication method to be used in the image processing apparatus 40 referring to the authentication method information read out from the authentication method information storage unit 34, based on the information of the staying person received by the reception unit 31. In particular, in the second aspect, the authentication method selection unit 35 determines whether or not the selected authentication method is the default authentication method. In the present exemplary embodiment, this processing of the authentication method selection unit 35 is performed as an example of selecting a specific authentication method to be used when the apparatus authenticates the user in accordance with the staying person information, from a plurality of authentication methods. Further, in the present exemplary embodiment, this processing of the authentication method selection unit 35 is performed as an example of the following. When the staying person information regarding a staying person standing around the apparatus is the first information, the first authentication method is selected as the specific authentication method used when the apparatus authenticates the user from the plurality of authentication methods. When the staying person information is the second information, the second authentication method is selected as the specific authentication method from the plurality of authentication methods.

Here, the information of the staying person may be any information regarding the staying person.

For example, it is assumed that the information of the staying person is the number of the staying persons. In this case, the authentication method selection unit 35 selects a certain authentication method when the number of staying persons is a certain number, and selects another authentication method having a higher security level than the certain authentication method when the number of staying persons is different number larger than the certain number. In the present exemplary embodiment, this processing of the authentication method selection unit 35 is performed as an example of the following. When the number of staying persons is a first number, the first authentication method is selected as the specific authentication method, and when the number of staying persons is a second number larger than the first number, the second authentication method having a higher security level than the first authentication method is selected as the specific authentication method.

Further, it is assumed that the information of the staying person is a state of the staying person. In this case, the authentication method selection unit 35 selects a certain authentication method when the state of the staying person is in a certain state, and selects another authentication method having a higher security level than the certain authentication method when the state of the staying person is in another state in which the degree of threat to authentication is higher than the certain state. Here, “the degree of threat to authentication is higher” means that the state of the staying person is a state in which the risk of the user authentication information of the user performing operation being stolen is high. In the present exemplary embodiment, this processing of the authentication method selection unit 35 is performed as an example of the following. When the staying person state is a first state, the first authentication method is selected as the specific authentication method, and when the staying person state is a second state in which the degree of threat to authentication is higher than the first state, the second authentication method having a higher security level than the first authentication method is selected as the specific authentication method.

Further, when the information of the staying person is the state of the staying person, it is assumed that the state of the staying person is the orientation of the staying person. In this case, the authentication method selection unit 35 selects a certain authentication method when the orientation of the staying person is not directed to the image processing apparatus 40, and selects another authentication method having a higher security level than the certain authentication method when the orientation of the staying person is directed to the image processing apparatus 40. In the present exemplary embodiment, the processing of the authentication method selection unit 35 is performed as an example of the following. When the staying person state, being the staying person orientation, is in a state in which the orientation of the staying person is not directed to the apparatus, the first authentication method is selected, and when the staying person state, being the staying person orientation, is in a state in which the orientation of the staying person is directed to the apparatus, the second authentication method having a higher security level than the first authentication method is selected.

In particular, in the third and fourth aspects, the authentication method selection unit 35 selects an authentication method to be used by the image processing apparatus 40 referring to the authentication method information read out from the authentication method information storage unit 34, based on the information of the existing person received by the reception unit 31 in addition to the information of the staying person received by the reception unit 31. In the present exemplary embodiment, the processing of the authentication method selection unit 35 is performed as an example of selecting a specific authentication method from a plurality of authentication methods further in accordance with the existing person information.

In the third aspect, the authentication method selection unit 35 selects the authentication method to be used in the image processing apparatus 40 based on the information of the passerby around the image processing apparatus 40 received by the reception unit 31 as the information of the existing person, in addition to the information of the staying person received by the reception unit 31. Here, as described above, the information of the staying person is information detected by the reflection sensor 49a, and the information of the passerby is information detected by the vibration sensor 49d. In the present exemplary embodiment, the reflection sensor 49a is used as an example of a first type sensor, and information of a staying person detected by the reflection sensor 49a is used as an example of the staying person information detected by the first type sensor. Further, in the present exemplary embodiment, the vibration sensor 49d is used as an example of a second type sensor different from the first type, and information of a passerby detected by the vibration sensor 49d is used as an example of the existing person information detected by the second type sensor.

Further, in the fourth aspect, the authentication method selection unit 35 selects the authentication method to be used in the image processing apparatus 40 based on the congestion degree of persons around the image processing apparatus 40 received by the reception unit 31 as the information of the existing person, in addition to the information of the staying person received by the reception unit 31. Here, as described above, the information of the staying person is the information detected by the reflection sensor 49a, and the congestion degree is the information obtained from the map application 50. In the present exemplary embodiment, the reflection sensor 49a is used as an example of a sensor, and information of a staying person detected by the reflection sensor 49a is used as an example of staying person information detected by the sensor. In the present exemplary embodiment, the congestion degree obtained from the map application 50 is used as an example of the information accumulated in the apparatus in advance.

The user authentication information storage unit 36 stores, for each user, user authentication information used to authenticate the user. For example, in the examples of FIG. 4 to FIG. 7, the user authentication information is a password, a mail address, and a fingerprint. However, the user authentication information is not limited thereto, and other information may be used.

When the user performs an authentication operation by using the image processing apparatus 40, the authentication execution unit 37 determines whether or not the user authentication information received by the reception unit 31 is stored for the user ID received by the same reception unit 31, thereby executing user authentication.

When the user performs an operation to access the cloud server 20 to retrieve document data by using the image processing apparatus 40, the transmission unit 38 transmits the authentication method selected by the authentication method selection unit 35 to the image processing apparatus 40. Note that, in the second aspect, when the authentication method selected by the authentication method selection unit 35 is not the default authentication method, the transmission unit 38 transmits an instruction to change from the default authentication method to the selected authentication method, to the image processing apparatus 40. Further, when the authentication method selected by the authentication method selection unit 35 is the default authentication method, the transmission unit 38 transmits an instruction to maintain the default authentication method to the image processing apparatus 40.

When the user performs an authentication operation to retrieve the document data by using the image processing apparatus 40, in a case that the authentication of the user by the authentication execution unit 37 is successful, the transmission unit 38 transmits the document data read out by the document data management unit 33 to the image processing apparatus 40.

Further, when the user performs an authentication operation to retrieve document data by using the image processing apparatus 40, in a case that the authentication of the user by the authentication execution unit 37 fails, the transmission unit 38 transmits that the authentication has failed to the image processing apparatus 40.

Note that, in the present exemplary embodiment, the cloud server 20 is described to have all of the main functions of the image processing system 1, but is not limited thereto. The cloud server 20 may have part of the main functions of the image processing system 1, and the image processing apparatus 40 may have the remaining part of the main functions of the image processing system 1. For example, the image processing apparatus 40 may include the user authentication information storage unit 36 and the authentication execution unit 37, and the user authentication after the authentication method is transmitted from the cloud server 20 may be performed by the image processing apparatus 40.

### Operation of Image Processing System

### First Aspect

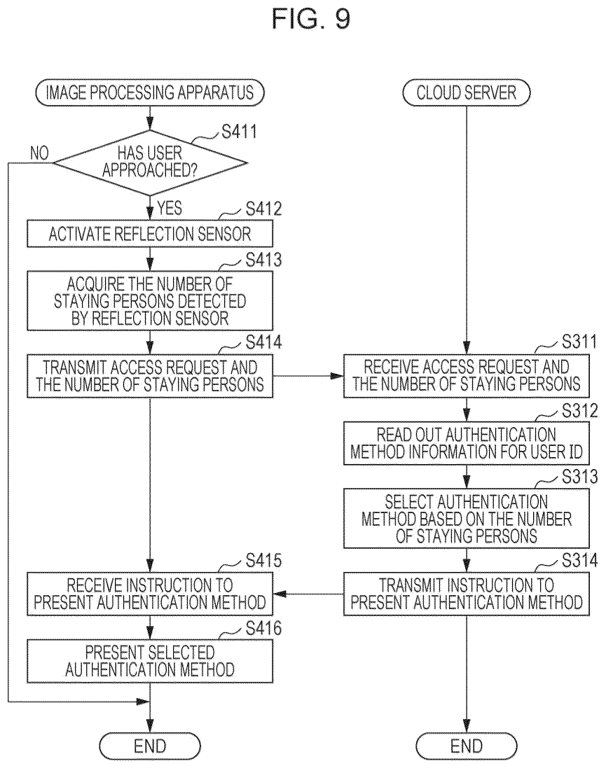

FIG. 9 is a sequence diagram illustrating an operation example of the image processing system 1 of the first aspect. Prior to this operation example, the user creates document data using the terminal apparatus 10, and transmits a document registration request including the user ID, the document ID, and the document data to the cloud server 20. With this, in the cloud server 20, the reception unit 31 receives the document registration request. The document data management unit 33 stores the document data included in the document registration request in the document data storage unit 32, and also holds the user ID and the document ID included in the document registration request being associated with each other.

Thereafter, as illustrated in the figure, the image processing apparatus 40 determines whether or not a user has made an approach (step 411). For example, the image processing apparatus 40 may determine whether or not the user has made an approach, based on whether or not the operation panel 45 is pressed. The user mentioned here includes not only the user who registered the document data but also another user who has approached the image processing apparatus 40 in order to operate the image processing apparatus 40.

When it is determined in step 411 that the user is not approaching, the image processing apparatus 40 ends the process.

On the other hand, when it is determined in step 411 that the user is approaching, the image processing apparatus 40 activates the reflection sensor 49a (step 412). The image processing apparatus 40 acquires the number of staying persons detected by the reflection sensor 49a (step 413). Here, it is assumed that the user logs in to the cloud server 20 by using the image processing apparatus 40 and performs an operation of selecting document data. The image processing apparatus 40 transmits an access request to the cloud server 20 including the user ID and the document ID obtained by this operation and the number of staying persons acquired in step 413, to the cloud server 20 (step 414).

With this, in the cloud server 20, the reception unit 31 receives the access request and the number of staying persons from the image processing apparatus 40 (step 311).

The authentication method selection unit 35 reads out the authentication method information corresponding to the user ID included in the access request received in step 311 from the authentication method information storage unit 34 (step 312). The authentication method selection unit 35 selects an authentication method to be used for authenticating the user by the image processing apparatus 40 based on the number of staying persons received in step 311, referring to the authentication method information read out in step 312 (step 313).

Thereafter, the transmission unit 38 transmits an instruction to present the authentication method selected in step 313 to the image processing apparatus 40 (step 314).

The image processing apparatus 40 receives the instruction to present the authentication method from the cloud server 20 (step 415). The image processing apparatus 40 presents the authentication method selected in step 313 on the operation panel 45, for example, based on the instruction for presentation received in step 415 (step 416).

Thereafter, the user performs multi-factor authentication with the authentication method presented in step 416. The image processing apparatus 40 transmits an authentication request including the user authentication information to the cloud server 20.

With this, in the cloud server 20, the reception unit 31 receives the authentication request. Next, the authentication execution unit 37 determines whether or not a combination of the user ID included in the access request received in step 414 and the user authentication information included in the authentication request is stored in the user authentication information storage unit 36, thereby executing user authentication. As a result, in a case that the authentication of the user fails, the transmission unit 38 transmits that the authentication has failed to the image processing apparatus 40. On the other hand, in a case that the user authentication is successful, the document data management unit 33 reads out the document data from the document data storage unit 32 based on the document ID associated with the user ID, and the transmission unit 38 transmits the document data to the image processing apparatus 40.

The image processing apparatus 40 receives the document data from the cloud server 20 and prints the document data.

### Second Aspect

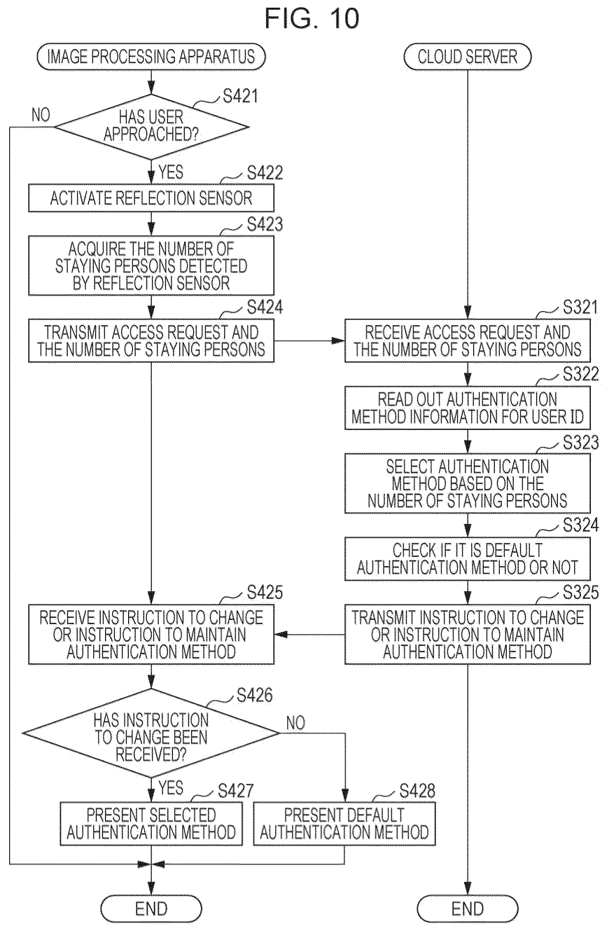

FIG. 10 is a sequence diagram illustrating an operation example of the image processing system 1 of the second aspect. The operation for registering document data, which is performed prior to this operation example, is the same as that described in the first aspect, and therefore, a description thereof is omitted.

Thereafter, as illustrated in the figure, the image processing apparatus 40 determines whether or not a user has made an approach (step 421). For example, the image processing apparatus 40 may determine whether or not the user has made an approach, based on whether or not the operation panel 45 is pressed. The user mentioned here includes not only the user who registered the document data but also another user who has approached the image processing apparatus 40 in order to operate the image processing apparatus 40.

When it is determined in step 421 that the user is not approaching, the image processing apparatus 40 ends the process.

On the other hand, when it is determined in step 421 that the user has made an approach, the image processing apparatus 40 activates the reflection sensor 49a (step 422). Next, the image processing apparatus 40 acquires the number of staying persons detected by the reflection sensor 49a (step 423). Here, it is assumed that the user logs in to the cloud server 20 by using the image processing apparatus 40 and performs an operation of selecting document data. The image processing apparatus 40 transmits an access request to the cloud server 20 including the user ID and the document ID obtained by this operation and the number of staying persons acquired in step 423, to the cloud server 20 (step 424).

With this, in the cloud server 20, the reception unit 31 receives the access request and the number of staying persons from the image processing apparatus 40 (step 321).

The authentication method selection unit 35 reads out the authentication method information corresponding to the user ID included in the access request received in step 321 from the authentication method information storage unit 34 (step 322). The authentication method selection unit 35 selects an authentication method to be used for authenticating the user by the image processing apparatus 40 based on the number of staying persons received in step 321, referring to the authentication method information read out in step 322 (step 323). Further, the authentication method selection unit 35 refers to the authentication method information read out in step 322 and checks whether or not the authentication method selected in step 323 is a default authentication method (step 324).

Thereafter, the transmission unit 38 transmits an instruction to change or maintain the authentication method, depending on whether or not the authentication method selected in step 323 is the default authentication method (step 325). Specifically, when it is determined that the authentication method selected in step 323 is not the default authentication method, the transmission unit 38 transmits an instruction to change the authentication method from the default authentication method to the selected authentication method, to the image processing apparatus 40. On the other hand, when it is determined that the authentication method selected in step 323 is the default authentication method, the transmission unit 38 transmits an instruction to maintain the default authentication method to the image processing apparatus 40.

The image processing apparatus 40 receives the instruction to change or maintain the authentication method from the cloud server 20 (step 425). The image processing apparatus 40 determines whether or not the instruction to change the authentication method has been received in step 425 (step 426).

Assume that an instruction to change the authentication method has been received in step 426. In this case, the image processing apparatus 40 changes the default authentication method to the authentication method selected in step 323, and presents the selected authentication method on the operation panel 45, for example (step 427).

On the other hand, if it is assumed that the instruction to change the authentication method has not been received in step 426. That is, it is assumed that an instruction to maintain the authentication method has been received in step 426. In this case, the image processing apparatus 40 does not change the default authentication method to the authentication method selected in step 323 and presents the default authentication method on the operation panel 45, for example (step 428).

The subsequent operation for printing the document data is the same as that described in the first aspect, and a description thereof will be omitted.

### Third Aspect

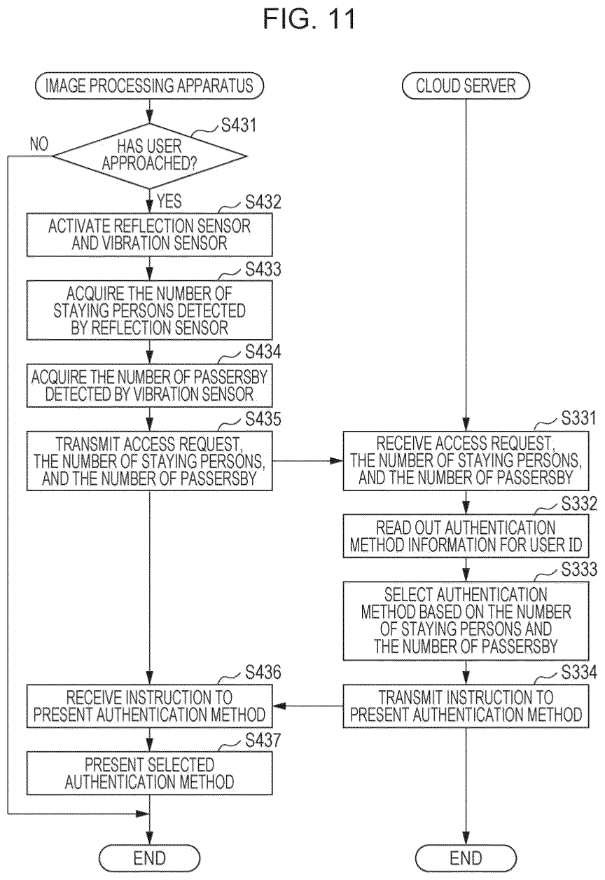

FIG. 11 is a sequence diagram illustrating an operation example of the image processing system 1 of the third aspect. The operation for registering document data, which is performed prior to this operation example, is the same as that described in the first aspect, and therefore, a description thereof is omitted.

Thereafter, as illustrated in the figure, the image processing apparatus 40 determines whether or not a user has made an approach (step 431). For example, the image processing apparatus 40 may determine whether or not the user has made an approach, based on whether or not the operation panel 45 is pressed. The user mentioned here includes not only the user who registered the document data but also another user who has approached the image processing apparatus 40 in order to operate the image processing apparatus 40.

When it is determined in step 431 that the user is not approaching, the image processing apparatus 40 ends the process.

On the other hand, when it is determined in step 431 that the user has made an approach, the image processing apparatus 40 activates the reflection sensor 49a and the vibration sensor 49d (step 432). The image processing apparatus 40 acquires the number of staying persons detected by the reflection sensor 49a (step 433), and acquires the number of passersby detected by the vibration sensor 49d (step 434). Here, it is assumed that the user logs in to the cloud server 20 by using the image processing apparatus 40 and performs an operation of selecting document data. The image processing apparatus 40 transmits an access request to the cloud server 20 including the user ID and the document ID obtained by this operation, the number of staying persons acquired in step 433, and the number of passersby acquired in step 434, to the cloud server 20 (step 435).

With this, in the cloud server 20, the reception unit 31 receives the access request, the number of staying persons, and the number of passersby from the image processing apparatus 40 (step 331).

The authentication method selection unit 35 reads out the authentication method information corresponding to the user ID included in the access request received in step 331 from the authentication method information storage unit 34 (step 332). The authentication method selection unit 35 selects an authentication method to be used for authenticating the user by the image processing apparatus 40 based on the number of staying persons and the number of passersby received in step 331, referring to the authentication method information read out in step 332 (step 333).

Thereafter, the transmission unit 38 transmits an instruction to present the authentication method selected in step 333 to the image processing apparatus 40 (step 334).

The image processing apparatus 40 receives the instruction to present the authentication method from the cloud server 20 (step 436). The image processing apparatus 40 presents the authentication method selected in step 333 on the operation panel 45, for example, based on the instruction to present received in step 436 (step 437).

The subsequent operation for printing the document data is the same as that described in the first aspect, and a description thereof will be omitted.

### Fourth Aspect

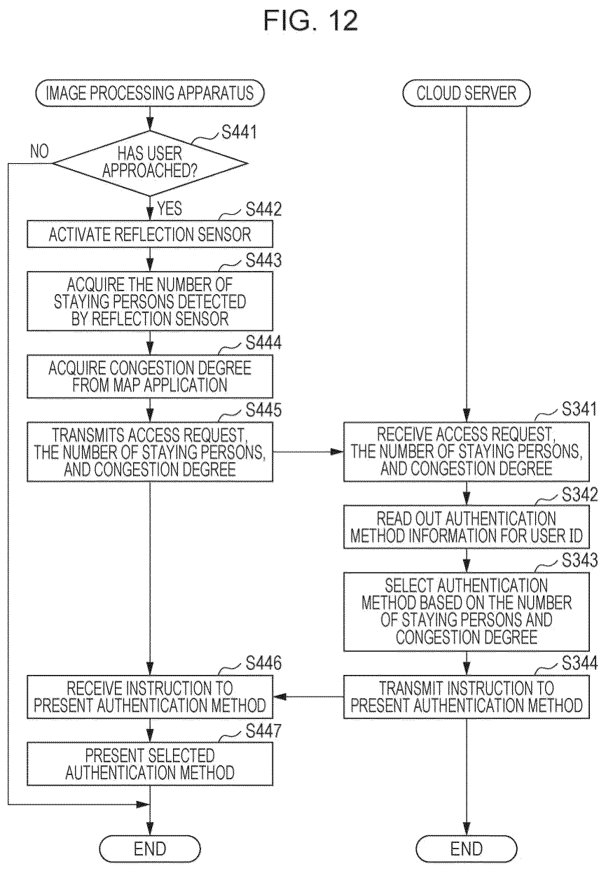

FIG. 12 is a sequence diagram illustrating an operation example of the image processing system 1 of the fourth aspect. The operation for registering document data, which is performed prior to this operation example, is the same as that described in the first aspect, and therefore, a description thereof is omitted.

Thereafter, as illustrated in the figure, the image processing apparatus 40 determines whether or not a user has made an approach (step 441). For example, the image processing apparatus 40 may determine whether or not the user has made an approach, based on whether or not the operation panel 45 is pressed. The user mentioned here includes not only the user who registered the document data but also another user who has approached the image processing apparatus 40 in order to operate the image processing apparatus 40.

When it is determined in step 441 that the user is not approaching, the image processing apparatus 40 ends the process.

On the other hand, when it is determined in step 441 that the user has made an approach, the image processing apparatus 40 activates the reflection sensor 49a (step 442). The image processing apparatus 40 acquires the number of staying persons detected by the reflection sensor 49a (step 443), and acquires the congestion degree from the map application 50 (step 444). Here, it is assumed that the user logs in to the cloud server 20 by using the image processing apparatus 40 and performs an operation of selecting document data. The image processing apparatus 40 transmits an access request to the cloud server 20 including the user ID and the document ID obtained by this operation, the number of staying persons acquired in step 443, and the congestion degree acquired in step 444, to the cloud server 20 (step 445).

With this, in the cloud server 20, the reception unit 31 receives the access request, the number of staying persons, and the congestion degree from the image processing apparatus 40 (step 341).

The authentication method selection unit 35 reads out the authentication method information corresponding to the user ID included in the access request received in step 341 from the authentication method information storage unit 34 (step 342). The authentication method selection unit 35 selects an authentication method to be used for authenticating the user in the image processing apparatus 40 based on the number of staying persons and the congestion degree received in step 341, referring to the authentication method information read out in step 342 (step 343).

Thereafter, the transmission unit 38 transmits an instruction to present the authentication method selected in step 343 to the image processing apparatus 40 (step 344).

The image processing apparatus 40 receives the instruction to present the authentication method from the cloud server 20 (step 446). The image processing apparatus 40 presents the authentication method selected in step 343 on the operation panel 45, for example, based on the instruction to present received in step 446 (step 447).

The subsequent operation for printing the document data is the same as that described in the first aspect, and a description thereof will be omitted.

### Processor

In the present exemplary embodiment, the processor refers to a processor in a broad sense, and includes a general-purpose processor (for example, Central Processing Unit (CPU), and the like) and a dedicated processor (for example, Graphics Processing Unit (GPU), Application Specific Integrated Circuit (ASIC), Field Programmable Gate Array (FPGA), programmable logic devices, and the like).

Further, the operation of the processor in the present exemplary embodiment may be performed not only by one processor but also by a plurality of processors existing at physically distant locations in cooperation with each other. Further, the order of the operations of the processor is not limited to the order described in the present exemplary embodiment, and may be changed.

### Program

The processing performed by the cloud server 20 in the present exemplary embodiment is prepared as, for example, a program such as application software.

In this case, the program for achieving the present exemplary embodiment is regarded as a program for causing a computer to achieve a function of acquiring staying person information regarding a staying person standing around the apparatus and a function of selecting a specific authentication method used when the apparatus authenticates a user in accordance with the staying person information from a plurality of authentication methods.

The program for achieving the exemplary embodiment can be provided with a communication method and also with a program being stored in a recording medium such as a CD-ROM.

### APPENDIX

(((1)))

An information processing system comprising:
one or a plurality of processors configured to:
   acquire staying person information regarding a staying person standing around an apparatus; and
   select a specific authentication method used when the apparatus authenticates a user in accordance with the staying person information, from a plurality of authentication methods.
      (((2)))

The information processing system according to (((1))), wherein the plurality of authentication methods are predetermined for the user.

(((3)))

The information processing system according to (((1))) or (((2))), wherein
the one or the plurality of processors are configured to:
   acquire the number of staying persons as the staying person information;
   select a first authentication method as the specific authentication method in a case that the number of staying persons is a first number; and
   select a second authentication method having a higher security level than the first authentication method as the specific authentication method in a case that the number of staying persons is a second number larger than the first number.
      (((4)))

The information processing system according to any one of (((1))) to (((3))), wherein
the one or the plurality of processors are configured to:
   acquire the state of the staying person as the staying person information;
   select a first authentication method as the specific authentication method in a case that the state of the staying person is a first state; and
   select a second authentication method having a higher security level than the first authentication method as the specific authentication method in a case that the state of the staying person is a second state in which the degree of threat to the authentication is higher than that in the first state.
      (((5)))

The information processing system according to (((4))), wherein
the state of the staying person is an orientation of the staying person,
the first state is a state in which the orientation of the staying person is not directed to the apparatus, and
the second state is a state in which the orientation of the staying person is directed to the apparatus.
   (((6)))

The information processing system according to any one of (((1)) to (((5))), wherein
the one or the plurality of processors are configured to:
   further acquire existing person information regarding an existing person existing around the apparatus; and
   select the specific authentication method further in accordance with the existing person information from the plurality of authentication methods.
      (((7)))

The information processing system according to (((6))), wherein
the staying person information is information detected by a first type sensor, and
the existing person information is information detected by a second type sensor different from the first type.
   (((8)))

The information processing system according to (((6))), wherein
the staying person information is information detected by a sensor, and
the existing person information is information accumulated for the apparatus in advance.
   (((9)))

An information processing system comprising:
one or a plurality of processors configured to:
   select a first authentication method as a specific authentication method used when an apparatus authenticates a user from a plurality of authentication methods in a case that staying person information regarding a person who is standing around the apparatus is first information; and
   select a second authentication method as the specific authentication method from the plurality of authentication methods in a case that the staying person information is second information.
      (((10)))

A program causing a computer to execute a process comprising:
acquiring staying person information regarding a staying person standing around an apparatus; and
selecting a specific authentication method used when the apparatus authenticates a user in accordance with the staying person information, from a plurality of authentication methods.

What is claimed is:

1. An information processing system comprising:
one or a plurality of processors configured to:
acquire staying person information regarding a staying person standing around an apparatus; and
select a specific authentication method used when the apparatus authenticates a user in accordance with the staying person information, from a plurality of authentication methods.

2. The information processing system according to claim 1, wherein the plurality of authentication methods are predetermined for the user.

3. The information processing system according to claim 1, wherein
the one or the plurality of processors are configured to:
acquire the number of staying persons as the staying person information;
select a first authentication method as the specific authentication method in a case that the number of staying persons is a first number; and
select a second authentication method having a higher security level than the first authentication method as the specific authentication method in a case that the number of staying persons is a second number larger than the first number.

4. The information processing system according to claim 1, wherein
the one or the plurality of processors are configured to:
acquire the state of the staying person as the staying person information;
select a first authentication method as the specific authentication method in a case that the state of the staying person is a first state; and
select a second authentication method having a higher security level than the first authentication method as the specific authentication method in a case that the state of the staying person is a second state in which the degree of threat to the authentication is higher than that in the first state.

5. The information processing system according to claim 4, wherein
the state of the staying person is an orientation of the staying person,
the first state is a state in which the orientation of the staying person is not directed to the apparatus, and
the second state is a state in which the orientation of the staying person is directed to the apparatus.

6. The information processing system according to claim 1, wherein
the one or the plurality of processors are configured to:
further acquire existing person information regarding an existing person existing around the apparatus; and
select the specific authentication method further in accordance with the existing person information from the plurality of authentication methods.

7. The information processing system according to claim 6, wherein
the staying person information is information detected by a first type sensor, and
the existing person information is information detected by a second type sensor different from the first type.

8. The information processing system according to claim 6, wherein
the staying person information is information detected by a sensor, and
the existing person information is information accumulated for the apparatus in advance.

9. An information processing system comprising:
one or a plurality of processors configured to:
select a first authentication method as a specific authentication method used when an apparatus authenticates a user from a plurality of authentication methods in a case that staying person information regarding a person who is standing around the apparatus is first information; and
select a second authentication method as the specific authentication method from the plurality of authentication methods in a case that the staying person information is second information.

10. A non-transitory computer readable medium storing a program causing a computer to execute a process comprising:
acquiring staying person information regarding a staying person standing around an apparatus; and
selecting a specific authentication method used when the apparatus authenticates a user in accordance with the staying person information, from a plurality of authentication methods.
